(19) United States
(12) Patent Application Publication
(10) Pub. No.: US 2007/0096692 A1
(43) Pub. Date: May 3, 2007

(54) Electric power storage device with multiple voltage outputs

(75) Inventors: Hui-Chang Chuang, Taipei Hsien (TW); Ming-Cheng Lin, Taipei Hsien (TW)

Correspondence Address: BIRCH STEWART KOLASCH & BIRCH, PO BOX 747, FALLS CHURCH, VA, 22040-0747, US

(73) Assignee: SINBON ELECTRONICS COMPANY LTD.

(21) Appl. No.: 11/260,150

(22) Filed: Oct. 28, 2005

(51) Int. Cl. H02J 7/00

(52) U.S. Cl. 320/128

(57) ABSTRACT

An electric power storage device with multiple voltage outputs capable of providing electricity of various voltages for different electronic devices. The device includes a first switch and a second switch that connect to the electronic device; a voltage level-adjusting unit used to output a setting signal of a selected voltage level; a processing unit connecting to the first and second switches and the voltage level-adjusting unit to receive DC electricity and the setting signal to switch on/off the first switch and the second switch after some comparisons and operations; a charging circuit using DC electricity to charge a battery unit; and a voltage transformer connecting respectively to the processing unit, the battery unit, and the second switch to transform electricity obtained from the battery unit under a control of the processing unit and provide the transformed electricity for the electronic device via the second switch.

### BACKGROUND OF THE INVENTION

1. Field of the Invention

The present invention is related to an electric power storage device with multiple voltage outputs, and more particularly to an electric power storage device that can provide electricity of various voltages for different electronic devices.

2. Description of Related Art

Over the last 40 years computers have spread across the world becoming firstly an essential part of any office or workplace and now a commonplace item in most households throughout the developed world. They now provide a vast range of functions and are increasingly compact. Moreover, computer technologies are still progressing at a rapid rate. Personal computers, such as portable computers, notebook computers, and palm computers, are now becoming more and more common. Because small-scale computers are usually used without connecting to a municipal electrical grid, they need to obtain their electric supply from dry batteries or rechargeable batteries. Obviously, most notebook computers are equipped with rechargeable batteries because they can be used repeatedly.

Reference is made to FIG. 1, which is a schematic diagram of a conventional computer. When in use, the computer 10 obtains electricity from a rechargeable battery (not shown). The rechargeable battery connects to a plug 30 via an alternative current (AC) adapter 20 and obtains electricity from the municipal electrical grid thereby.

Reference is also made to FIG. 2, which is a block diagram of a conventional computer charging system. In the conventional computer charging system, AC adapter 20 coverts AC electricity from the municipal electrical grid into direct current (DC) electricity. A microprocessor 104 is connected respectively to AC adapter 20 and the rechargeable battery 108. The microprocessor 104 is used to check the power level of the rechargeable battery 108. If the power level of the rechargeable battery 108 is lower than a bottom threshold, the microprocessor 104 sends a charge-enable signal to the charging circuit 106. At this time, the charging circuit 106 uses the electricity from the municipal electrical grid to charge the rechargeable battery 108. When the power level of the rechargeable battery 108 reaches a top threshold, the microprocessor 104 sends a charge-disable signal to the charging circuit 106 to stop the charging operation.

In reference to the description above, since computers in the market have different voltage requirements, they should be equipped with specific AC adapters for charging their rechargeable batteries. It is inconvenient in use. Moreover, the electrical capacity of rechargeable batteries is finite. Without being charged by electricity from the municipal electrical grid through AC adapters, the electricity from rechargeable batteries runs out quickly. Once the electricity of the rechargeable batteries runs out, a computer is forced to shut down. Hence, when in use, the computers are unstable without a supply of electricity from the municipal electrical grid.

Accordingly, as discussed above, the prior art still has some drawbacks that could be improved upon. The present invention aims to resolve the drawbacks of the prior art.

### SUMMARY OF THE INVENTION

An objective of the present invention is to provide an electric power storage device with multiple voltage outputs, used to output various voltage levels for different electronic devices. The present invention can also provide electricity for rechargeable batteries of electronic devices when the electronic devices are used in an environment where electricity from the municipal electrical grid is unavailable.

For achieving the objective above, the present invention provides an electric power storage device with multiple voltage outputs. The device of the present invention is connected respectively to an alternative current (AC) adapter and an electronic device. The electric power storage device is used to receive direct current (DC) electricity from AC adapter and provide the voltage outputs to the electronic device. The electric power storage device of the present invention includes a first switch connecting to the electronic device; a second switch connecting to the electronic device; a voltage level-adjusting unit used to output a setting signal of a selected voltage level; a processing unit connecting respectively to the first switch, the second switch, and the voltage level-adjusting unit to receive DC electricity and the setting signal of the selected voltage level to switch on/off the first switch and the second switch after comparisons and operations; a charging circuit using DC electricity to charge the a battery unit; and a voltage transformer connecting respectively to the processing unit, the battery unit, and the second switch to transform electricity obtained from the battery unit under a control of the processing unit and provide the transformed electricity for the electronic device via the second switch.

For achieving the objective above, the present invention provides another electric power storage device with multiple voltage outputs. The electric power storage device receives DC electricity and provides the voltage outputs to an electronic device. The electric power storage device of the present invention includes a first switch connecting to the electronic device; a second switch connecting to the electronic device; a voltage level-adjusting unit used to output a setting signal of a selected voltage level; a processing unit connecting respectively to the first switch, the second switch, and the voltage level-adjusting unit to receive DC electricity and the setting signal of the selected voltage level to switch on/off the first switch and the second switch after comparisons and operations; and a voltage transformer connecting respectively to the processing unit, the second switch, and a battery unit to transform electricity obtained from the battery unit under a control of the processing unit and provide the transformed electricity for the electronic device via the second switch.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram of a conventional computer;

FIG. 2 is a block diagram of a conventional computer charging system;

FIG. 3 is a schematic diagram of the present invention;

FIG. 4 is a block diagram of the present invention; and

FIG. 5 is a circuit diagram of the present invention.

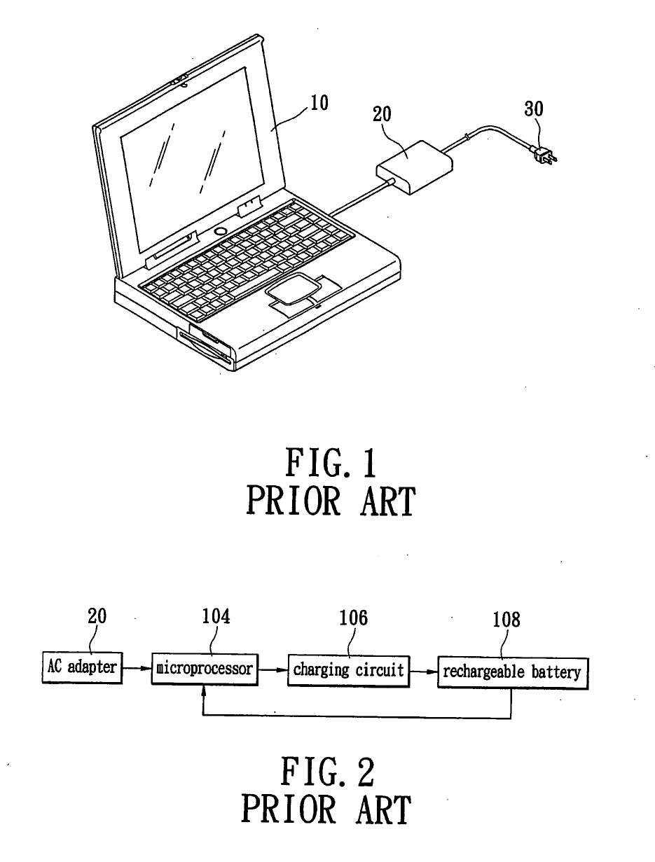

### DETAILED DESCRIPTION OF PREFERRED EMBODIMENTS

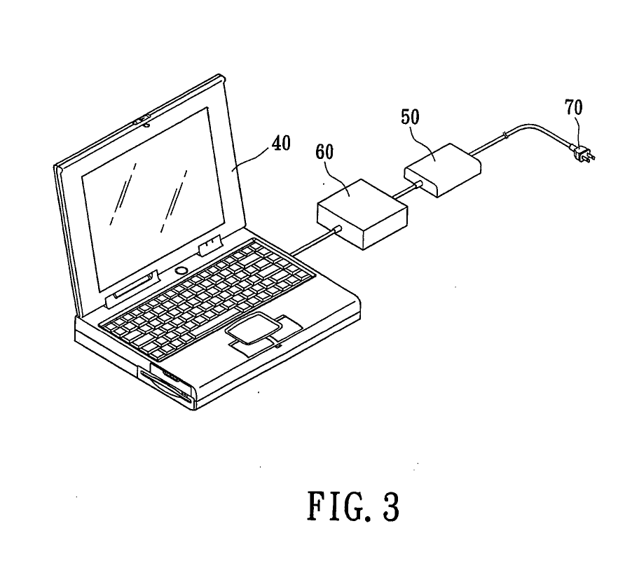

Reference is made to FIG. 3, which is a schematic diagram of the present invention. In the present invention, an electric power storage device 60 with multiple voltage outputs is provided. The electric power storage device 60 connects respectively to an AC adapter 50 and an electronic device 40. It receives DC electricity from AC adapter 50, which converts AC electricity from the municipal electrical grid obtained from a plug 70 into DC electricity. Due to operations of the internal circuit, the electric power storage device 60 can provide multiple voltage outputs to the electronic device 40.

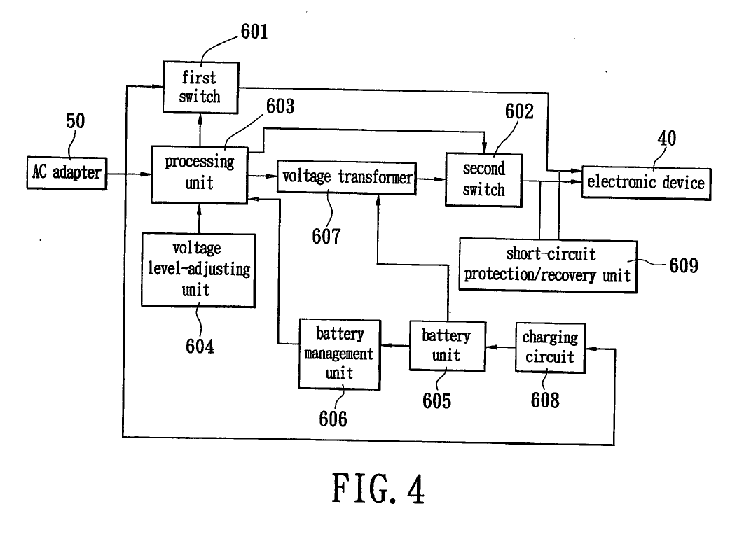

Reference is made to FIG. 4, which is a block diagram of the present invention. The present invention connects respectively to an AC adapter 50 and an electronic device 40. It receives DC electricity and provides multiple voltage outputs to the electronic device 40. The present invention has a first switch 601 connecting respectively to the electronic device 40 and the AC adapter 50; a second switch 602 connects to the electronic device 40; a voltage level-adjusting unit 604 is used to output a setting signal of a selected voltage level; a processing unit 603 connects respectively to the first switch 601, the second switch 602, and the voltage level-adjusting unit 604 to receive DC electricity and the setting signal of the selected voltage level and to switch on/off the first switch 601 and the second switch 602 after some comparisons and operations; a charging circuit 608 that uses DC electricity to charge the battery unit 605; and a voltage transformer 607 connects respectively to the processing unit 603, the battery unit 605, and the second switch 602 to transform electricity obtained from the battery unit 605 under the control of the processing unit 603 and provide it to the electronic device 40 via the second switch 602.

As shown in FIG. 4, the present invention further has a battery management unit 606 connecting respectively to the processing unit 603 and the battery unit 605. The battery management unit 606 obtains the status information of the battery unit 605 and passes it to the processing unit. In addition, the battery management unit 606 can be used to control the electric current outputted to the electronic device 40 according to the setting signal issued from the voltage level-adjusting unit 604 to provide dynamic overload protection. Therein, dynamic overload protection is performed by the processing unit 603, which executes a program to obtain the voltage level of the battery unit 605 and then change the amount of the outputted electric current accordingly. The present invention further has a short-circuit protection/recovery unit 609 connecting respectively to the first switch 601 and the second switch 602 for restriction of the output voltage when a short circuit occurs and for recovering normal operations as well.

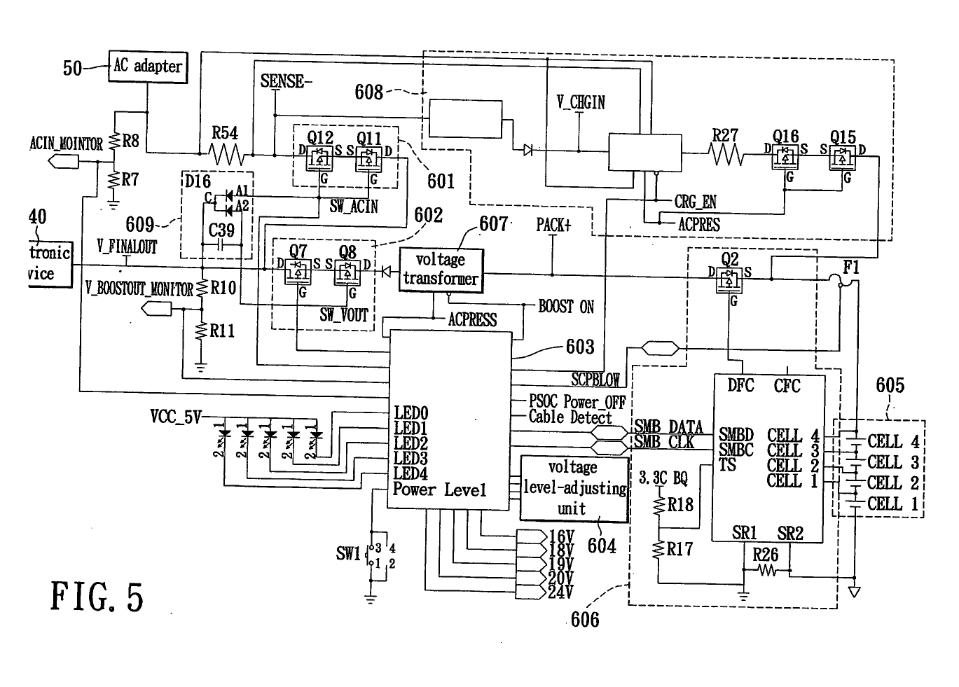

Reference is made to FIG. 4 together with FIG. 5, which is a circuit diagram of the present invention. In the present invention, the processing unit 603 (PSOC chip) is connected to an AC adapter via two resistors R7 and R8, which are used for voltage division. Thereby, according to the principle of voltage division, the processing unit 603 can obtain DC electricity provided from the AC adapter 50. The processing unit 603 (PSOC chip) firstly measures the voltage level of DC electricity obtained externally and then compares it with the selected voltage level of the voltage level-adjusting unit 604. If the two voltage levels are the same, the processing unit 603 uses its output end SW_ACIN to issue a signal to switch on the MOSFET switches Q11 and Q12. At this time, DC electricity is provided for the charging circuit 608 to simultaneously charge the battery unit 605 and the electronic device 40.

In the description above, if the voltage level of DC electricity is not the same as the selected voltage level of the voltage level-adjusting unit 604, the processing unit 603 uses the output end SW_ACIN to issue a signal to switch off the MOSFET switches Q11 and Q12. At this time, DC electricity is only provided to charge the battery unit 605. In this way, the electricity with incorrect voltage will not be outputted to the electronic device 40. Thus, the electronic device 40 is protected from being damaged.

Please refer to FIG. 5. Suppose that the voltage of DC electricity outputted from AC adapter 50 is 15V. The voltage of DC electricity is first divided by the resistors R7 and R8 and then passed to the processing unit 603 to be compared with the selected voltage level of the voltage level-adjusting unit 604. At this time, if the selected voltage level of the voltage level-adjusting unit 604 is also 15V, the processing unit 603 uses its output end SW_ACIN to issue a signal to switch on the MOSFET switches Q11 and Q12 of the first switch 601. At this time, DC electricity obtained from the AD adapter 50 is provided to the electronic device 40 via the output end V_FINALOUT. Otherwise, the processing unit 603 uses the output end SW_ACIN to switch off the MOSFET switches Q11 and Q12. At this time, DC electricity is only provided to charge the battery unit 605. In this way, electricity of an incorrect voltage will not be outputted to the electronic device 40. Thus, the electronic device 40 is protected from being damaged.

Please refer to FIG. 5 again. When DC electricity outputted from AC adapter 50 is cut off, the device of the present invention starts discharging electricity, instead of being charged. At this time, the output end SW_ACIN of the processing unit 603 maintains a low voltage, but the output end SW_OUT is used to send a signal to switch on the MOSET switches Q7 and Q8 of the second switch 602. At this time, the battery unit 605 provides electricity of a correct voltage to the electronic device 40 via the voltage transformer 607 together with the MOSET switches Q7 and Q8. Similarly, the processing unit 603 will compare the voltage level of the electricity outputted from the voltage transformer 607 with the selected voltage level of the voltage level-adjusting unit 604. If these two voltage levels are not the same or the voltage level of the voltage level-adjusting unit 604 is changed during the electricity discharging duration, the processing unit 603 keeps the output end SW_OUT with low voltage to switch off the MOSET switches Q7 and Q8. In this situation, the output end V_FINALOUT will not provide electricity of the required voltage to the electronic device 40.

In the description above, if the voltage level of the voltage level-adjusting unit 604 is recovered to the original level and the signal transmission line located between the present invention's device and the electronic device 40 is inserted again, a detecting pin of the processing unit 603 will receive a reset signal. At this time, the processing unit 603 will perform the voltage level comparison operation again. If the voltage level of the electricity outputted from the voltage transformer 607 is the same as the selected voltage level of the voltage level-adjusting unit 604, the processing unit 603 will control its output end SW_VOUT to switch on the MOSFET switches Q7 and Q8. Thereby, electricity is provided to the electronic device 40 via the output end V_FINALOUT. Otherwise, if the voltage level of the electricity outputted from the voltage transformer 607 is different from the selected voltage level of the voltage level-adjusting unit 604, the MOSFET switches Q7 and Q8 will be switched off until the two voltage levels are adjusted to the same level.

Please refer to FIG. 5 again. The present invention further has a protection function that can recover normal operations automatically after a short circuit occurs at the output end. This function is performed by the short-circuit protection/recovery unit 609, which connects respectively to the first switch 601 and the second switch 602. The short-circuit protection/recovery unit 609 comprises a diode D16. When a short circuit occurs, the voltage of the output end V_FINALOUT drops to a low level. Since the diode D16 is forward biased, the output end V_FINALOUT with a low voltage level makes voltages of the output ends SW_ACIN and SW_VOUT drop to a low level. Thus, the MOSFET switches Q7 and Q8 or the MOSFET switches Q11 and Q12 are switched off to isolate the present invention's device from the electronic device 40 so that the electronic device 40 is protected from being damaged. Moreover, when the condition that caused the short circuit is removed, the normal voltage levels of the output ends SW_ACIN and SW_VOUT are recovered due to the separation provided by the reverse-biased diode D16. Thus, the MOSFET switches Q7 and Q8 or the MOSFET switches Q11 and Q12 are switched on again. In this way, the connection between the present invention's device and the electronic device 40 is recovered.

Conventionally, short-circuit protection is provided by using fuse wires. Although fuse wires can be used to provide short-circuit protection, they cannot be recovered automatically once they have been fused. On the contrary, the short-circuit protection function of the present invention can be recovered automatically due to its hardware circuit.

Please refer to FIG. 5 again. The present invention also has an output overload protection function. According to the selected voltage level of the voltage level-adjusting unit 604, the device of the present invention restricts the output power by using the current value provided by the battery management unit 606. In conditions in which the output power is fixed, when the output voltage alters, the input current should be changed accordingly to provide dynamic overload protection.

For example, according to the law of the conservation of energy, input power must equal output power, which can be expressed as:
Pout=Pin=Vout*Iout=Vin*Iin. (1)

Suppose that the maximum output power Pout is restricted to 100 W, the output voltage is Vout=24V, the output current is Iout=4.16 A, and the input voltage is Vin=16V. Hence, the equation (1) can be rewritten as:
Pout=100 W=24V*4.16 A=16V*Iin.

After calculation, we can obtain that Iin=6.25 A. Hence, the input current should be restricted to 6.25 A. When the input voltage Vin (voltage of the battery) drops to 12V, according to equation (1), we have
Pout=100 W=24V*4.16 A=12V*Iin.
After calculation, we can obtain that Iin=8.33 A. Hence, the restriction of the input current should be changed to 8.33 A.

The present invention provides the output overload protection function by using the processing unit 603 to execute a program. Due to the execution of the program, the processing unit 603 can read the voltage value of the battery unit 605 via the battery management unit 606 (i.e. BQ2060 IC) for calculation of the value of input current. Then, the processing unit 603 changes the restriction of input current according to the calculation result to provide the output overload protection function.

To sum up, the present invention uses the processing unit 603 to memorize the value of the voltage inputted externally and check whether the input voltage level is the same as the selected voltage level of the voltage level-adjusting unit 604. If these two voltage levels are the same, the electricity inputted externally can be passed to the electronic device 40 directly and used to charge the device of the present invention. If the external electric power supply is removed, the device of the present invention outputs electricity according to the selected voltage level of the voltage level-adjusting unit 604. However, if the input voltage of the external electric power supply does not equal the selected voltage level of the voltage level-adjusting unit 604 when the external electric power supply inputs electricity to the device of the present invention, the device of the present invention is not allowed to output electricity when the external electric power supply is removed.

Furthermore, when the voltage level of the voltage level-adjusting unit 604 is selected, it can be confirmed by unplugging/plugging an external connection wire. Then, the device of the present invention starts to provide electricity. However, if the voltage level of the voltage level-adjusting unit 604 is changed in the electricity output duration, the device of the present invention will not output electricity until the external connection wire is unplugged and plugged in again. When the voltage level-adjusting unit 604 is turned off or the external connection wire is removed, the device of the present invention enters a sleep mode to save electricity.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are embraced within the scope of the invention as defined in the appended claims.

What is claimed is:

1. An electric power storage device with multiple voltage outputs, the electric power storage device receiving direct current (DC) electricity and being capable of providing the voltage outputs to an electronic device, the electric power storage device comprising: a first switch connecting to the electronic device;
a second switch connecting to the electronic device;
a voltage level-adjusting unit used to output a setting signal of a selected voltage level;
a processing unit connecting respectively to the first switch, the second switch, and the voltage level-adjusting unit to receive DC electricity and the setting signal of the selected voltage level to switch on/off the first switch and the second switch after comparisons and operations;
a charging circuit using DC electricity to charge a battery unit; and
a voltage transformer connecting respectively to the processing unit, the battery unit, and the second switch to transform electricity obtained from the battery unit under a control of the processing unit and providing the transformed electricity for the electronic device via the second switch.

2. The electric power storage device as claimed in claim 1, further comprising a battery management unit connecting respectively to the processing unit and the battery unit to obtain status information of the battery unit and pass the status information to the processing unit.

3. The electric power storage device as claimed in claim 2, wherein the battery management unit controls an outputted electric current according to the setting signal of the selected voltage level to provide a function of dynamic overload protection.

4. The electric power storage device as claimed in claim 3, wherein the function of the dynamic overload protection is performed by the processing unit, which executes a program to obtain a voltage level of the battery unit and then change an amount of the outputted electric current accordingly.

5. The electric power storage device as claimed in claim 1, further comprising a short-circuit protection/recovery unit connecting respectively to the first switch and the second switch for restriction of an output voltage when short circuit occurs and for recovery of normal operations as well.

6. An electric power storage device with multiple voltage outputs, the electric power storage device receiving DC electricity and being capable of providing the voltage outputs to an electronic device, the electric power storage device comprising:
a first switch connecting to the electronic device;
a second switch connecting to the electronic device;
a voltage level-adjusting unit used to output a setting signal of a selected voltage level;
a processing unit connecting respectively to the first switch, the second switch, and the voltage level-adjusting unit to receive DC electricity and the setting signal of the selected voltage level to switch on/off the first switch and the second switch after comparisons and operations; and
a voltage transformer connecting respectively to the processing unit, the second switch, and a battery unit to transform electricity obtained from the battery unit under a control of the processing unit and providing transformed electricity for the electronic device via the second switch.

7. The electric power storage device as claimed in claim 6, wherein the processing unit switches on the first switch and switches off the second switch to provide DC electricity for the electronic device via the first switch when a voltage level of DC electricity is the same as the selected voltage level of the voltage level-adjusting unit.
The electric power storage device as claimed in claim 6, wherein the processing unit switches off the first switch, switches on the second switch, and controls the voltage transformer to provide electricity obtained from the battery unit for the electronic device when a voltage level of DC electricity is different from the selected voltage level of the voltage level-adjusting unit.
